(19) United States
(12) Patent Application Publication
(10) Pub. No.: US 2026/0112959 A1
(43) Pub. Date: Apr. 23, 2026

(54) INTEGRATED CHARGER

(71) Applicant: Solution X Co., Ltd., Seoul (KR)

(72) Inventor: Se Wan CHOI, Seoul (KR)

(73) Assignee: Solution X Co., Ltd., Seoul (KR)

(21) Appl. No.: 19/115,795

(22) PCT Filed: Jul. 4, 2024
(86) PCT No.: PCT/KR2024/009441

§ 371 Date: Mar. 27, 2025

(30) Foreign Application Priority Data
Jul. 4, 2023 (KR) 10-2023-0086786
Jul. 4, 2024 (KR) 10-2024-0087975

(51) Int. Cl. H02M 1/00; B60L 53/22; H02M 1/084; H02M 1/088; H02M 7/797

(52) U.S. Cl. CPC H02M 1/0083; B60L 53/22; H02M 1/084; H02M 1/088; H02M 7/797

(57) ABSTRACT

An integrated charger includes a first isolated charger configured to convert AC voltage input from the outside into first DC voltage for charging a first battery and to provide the converted voltage to the first battery and a second isolated charger including a transformer having a first winding wire connected to a switching circuit of the first isolated charger connected to the first battery and a second winding wire electromagnetically coupled to the first winding wire to convert the magnitude of voltage of the first winding wire and to output the voltage having the converted magnitude and a rectification circuit configured to rectify the voltage of the second winding wire into second DC voltage having a smaller magnitude than the first DC voltage and to provide the rectified voltage to a second battery.

### CROSS-REFERENCE TO PRIOR APPLICATIONS

This Application is a National Stage Patent Application of PCT International Application No. PCT/KR2024/009441 (filed on Jul. 4, 2024), which claims priority to Korean Patent Application Nos. 10-2023-0086786 (filed on Jul. 4,2023) and 10-2024-0087975 (filed on Jul. 4, 2024), which are all hereby incorporated by reference in their entirety.

### BACKGROUND

The present invention relates to an integrated charger, and more particularly to an integrated charger capable of reducing the number of parts and miniaturizing the size of a product.

Electric vehicles, which are driven by a motor that converts electrical energy into kinetic energy instead of an engine that generates power by burning fossil fuels, are provided with various batteries. For example, an electric vehicle has a high-voltage, high-capacity battery configured to store electrical energy used to drive a motor configured to generate vehicle power and a low-voltage battery configured to provide power to electric parts used in the vehicle.

The high-voltage battery may be charged using a power converter, commonly referred to as an on-board charger (OBC). The OBC is a device that converts alternating current (AC) power from an external grid to produce direct current (DC) power having voltage sufficient to charge the high-voltage battery.

The low-voltage battery may be charged using a low-voltage DC-DC converter (LDC) that converts the voltage of the DC power stored in the high-voltage battery to an appropriately low voltage.

As such, typical electric vehicles are provided with an OBC and an LDC, and therefore a large number of parts are required to implement a device for charging a high-voltage battery and a low-voltage battery, and the device is difficult to miniaturize.

### SUMMARY

The present invention has been made in view of the above problems, and it is an object of the present invention to provide an integrated charger configured such that an OBC and a LDC share parts, thereby reducing the total number of parts and the size of a product.

As a means for achieving the above object, the present invention provides an integrated charger including:
a first isolated charger configured to convert AC voltage input from the outside into first DC voltage for charging a first battery and to provide the converted voltage to the first battery; and
a second isolated charger including a transformer having a first winding wire connected to a switching circuit of the first isolated charger connected to the first battery and a second winding wire electromagnetically coupled to the first winding wire to convert the magnitude of voltage of the first winding wire and to output the voltage having the converted magnitude and a rectification circuit configured to rectify the voltage of the second winding wire into second DC voltage having a smaller magnitude than the first DC voltage and to provide the rectified voltage to a second battery.

In an embodiment of the present invention, the AC voltage may be a multi-phase AC voltage having a plurality of phases, the first isolated charger may include a plurality of isolated AC-DC conversion circuits connected in parallel to the first battery in order to convert each phase of the multi-phase AC voltage, and the second isolated charger may generate the first winding wire-side voltage through switching control of switching elements included in the first battery-side switching circuit provided in two arbitrary isolated AC-DC conversion circuits among the plurality of isolated AC-DC conversion circuits.

In an embodiment of the present invention, the first battery-side switching circuit may include a first leg including a first switching element and a second switching element connected to both ends of the first battery, respectively, the first switching element and the second switching element being connected to each other in series, and a third switching element and a fourth switching element connected to both ends of the first battery, respectively, the third switching element and the fourth switching element being connected to each other in series, and a connection node of the first switching element and the second switching element and a connection node of the third switching element and the fourth switching element may be connected to both ends of the first winding wire, respectively.

In an embodiment of the present invention, the rectification circuit of the second isolated charger may include a first diode having a cathode connected to one end of the second winding wire, a second diode having a cathode connected to the other end of the second winding wire and an anode connected to an anode of the first diode, and an inductor having one end connected to a center end of the second winding wire, and both ends of the second battery may be connected between the other end of the inductor and the anode of the second diode.

In an embodiment of the present invention, the rectification circuit of the second isolated charger may include a fifth switching element and a sixth switching element each having one end connected to one end of the second winding wire and a seventh switching element and an eighth switching element each having one end connected to the other end of the second winding wire, the other end of the fifth switching element and the other end of the seventh switching element may be connected to one end of the second battery, and the other end of the sixth switching element and the other end of the eighth switching element may be connected to the other end of the second battery.

In an embodiment of the present invention, the rectification circuit of the second isolated charger may include a third diode having an anode connected to one end of the second winding wire, a fourth diode having a cathode connected to one end of the second winding wire, a fifth diode having an anode connected to the other end of the second winding wire, a sixth diode having a cathode connected to the other end of the second winding wire, and a non-isolated DC-DC converter circuit configured to convert the magnitude of voltage between the cathode of the third diode and the anode of the fourth diode and to provide the voltage having the converted magnitude to the second battery.

In an embodiment of the present invention, the first switching element and the second switching element may be alternately switched at the same cycle and duty, the third switching element and the fourth switching element may be alternately switched at the same cycle and duty as the first switching element, and the voltage at both ends of the first winding wire may be determined through phase difference control of the first switching element and the third switching element.

In an embodiment of the present invention, the voltage between the connection node of the third switching element and the fourth switching element and a negative electrode of the first battery may be fixed so as to occur during ½ of the switching cycle of the first to fourth switching elements.

According to an integrated charger of the present invention, a switching circuit (rectification circuit) of a direct current side of a conventional OBC and a switching circuit (inverter circuit) of a high-voltage side (input side) of a conventional LDC may be integrated, and therefore the number of elements may be reduced, whereby it is possible to achieve product miniaturization and to reduce the manufacturing costs, and the number of power conversion steps may be reduced, whereby it is possible to improve energy efficiency.

### BRIEF DESCRIPTION OF THE DRAWINGS

The following drawings attached to this specification illustrate preferred embodiments of the present invention and serve to provide a further understanding of the technical idea of the present invention together with the following detailed description of the invention, and therefore the present invention should not be construed as limited to the matters set forth in such drawings.

FIGS. 1 and 2 are circuit diagrams showing the structures of a conventional on-board charger and a low-voltage DC-DC converter.

FIG. 3 is a circuit diagram of an integrated charger according to an embodiment of the present invention.

FIG. 4 is a circuit diagram of an integrated charger according to another embodiment of the present invention.

FIG. 5 is a circuit diagram showing a more specific circuit configuration of an integrated charger according to yet another embodiment of the present invention.

FIG. 6 is a waveform diagram showing a switching state when a first isolated charger and a second isolated charger are operated simultaneously in the embodiment of FIG. 5.

FIGS. 7 and 8 are circuit diagrams showing other embodiments of the present invention in which rectification circuits of second isolated chargers are configured differently.

### DETAILED DESCRIPTION

Hereinafter, an integrated charger according to various embodiments of the present invention will be described in detail with reference to the accompanying drawings.

Specific structural or functional descriptions of embodiments disclosed herein are given only for illustration, and may be realized in various forms. Therefore, the present invention is not limited to specific embodiments, and the scope of the present invention includes all alterations, equivalents, and substitutes that fall within the technical scope of the present invention.

Although the terms “first”, “second”, etc. may be used herein to describe various elements, these terms must be used only to distinguish one element from another. For example, a first element may be referred to as a second element, and similarly, a second element may be referred to as a first element.

It should be understood that, when an element is referred to as being “connected to” another element, the element may be directly connected to or coupled to the other element, or intervening elements may be present.

A singular representation may include a plural representation unless it represents a definitely different meaning from the context. It will be further understood that the terms “comprises”, “has” and the like, when used in this specification, specify the presence of stated features, numbers, steps, operations, elements, components, or combinations thereof, but do not preclude the presence or addition of one or more other features, numbers, steps, operations, elements, components, or combinations thereof.

Unless otherwise defined, all terms, including technical and scientific terms, used in this specification have the same meanings as commonly understood by a person having ordinary skill in the art to which the present disclosure pertains. It will be further understood that terms, such as those defined in commonly used dictionaries, should be interpreted as having meanings consistent with their meanings in the context of the relevant art and the present disclosure, and are not to be interpreted in an idealized or overly formal sense unless expressly so defined herein.

First, in order to facilitate understanding of the present invention, the structures of a conventional on-board charger (OBC) and a low-voltage DC-DC converter (LDC) will be briefly described.

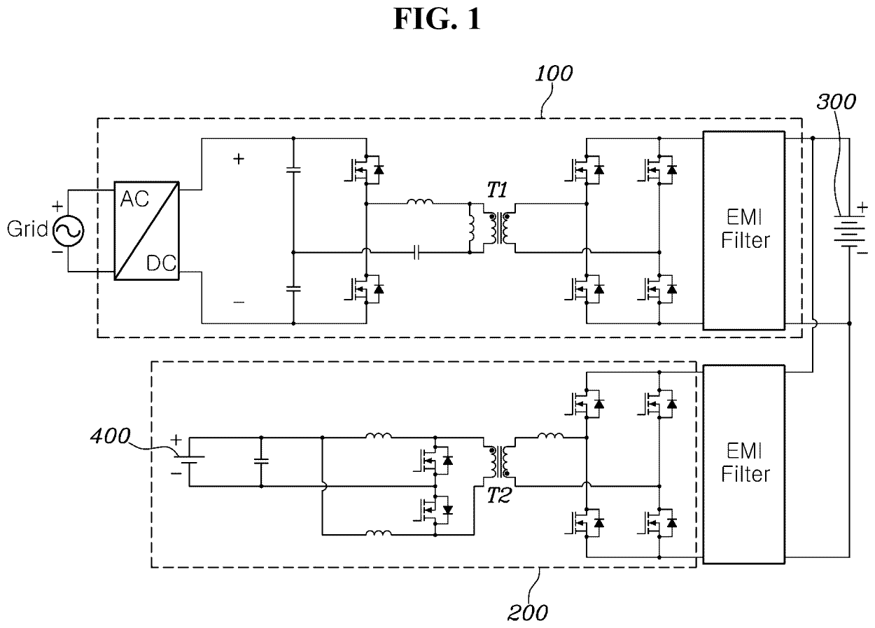

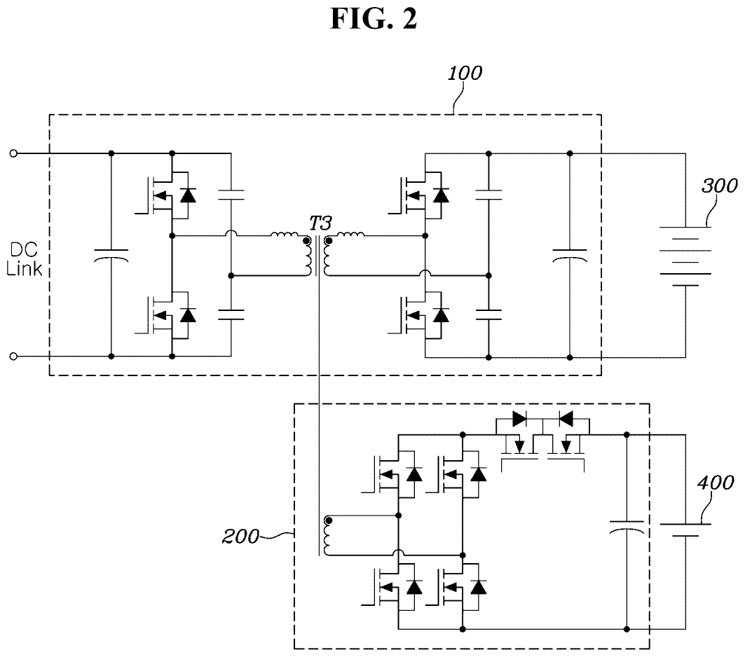

FIGS. 1 and 2 are circuit diagrams showing the structures of a conventional on-board charger and a low-voltage DC-DC converter. More specifically, FIG. 1 is a circuit diagram showing the structure in which the OBC and the LDC are separated from each other, and FIG. 2 is a circuit diagram showing the structure in which the OBC and the LDC share a transformer.

First, the conventional OBC and LDC circuit shown in FIG. 1 may include an OBC 100 having an input end connected to a grid and an output end connected to a high-voltage battery 300, the OBC having a structure in which the input and output ends are isolated from each other by a transformer T1, and an LDC 200 having an input end connected to the high-voltage battery 300 and an output end connected to a low-voltage battery 400, the LDC having a structure in which the input and output ends are isolated from each other by a transformer T2. A bridge circuit having switching elements connected thereto may be connected to a primary coil and a secondary coil of each of the transformer T1 and the transformer T2. FIG. 1 shows an example in which the OBC 100 has a two-stage structure including a stage for AC-DC conversion and a DC converter stage configured to convert DC voltage generated by a link capacitor at an output end of a block for AC-DC conversion, but this may be replaced by a one-stage structure in which a bridge circuit is connected directly to an input end of a grid to which alternating current is input such that energy is transferred to an output end through a transformer.

As shown in FIG. 1, the conventional OBC and LDC circuit has the disadvantage of separately providing a circuit for configuring the OBC 100 and a circuit for configuring the LDC 200, which requires a large number of devices and parts for realizing the circuits, and performing power conversion in multiple stages, which reduces efficiency.

In addition, the conventional OBC and LDC circuit shown in FIG. 2 has a structure in which the OBC 100 and the LDC 200 have an integrated transformer T3. FIG. 2 shows an output end to which a high-voltage battery 300 is connected from a DC link end of a rear end of a DC-AC conversion stage in the OBC 100.

In the conventional OBC and LDC circuit shown in FIG. 2, an attempt is made to reduce price and volume by using the integrated transformer T3, but the complexity in design and size of the transformer increase, which does not result in substantially reducing the size of the entire circuit or reducing the manufacturing costs due to fewer parts.

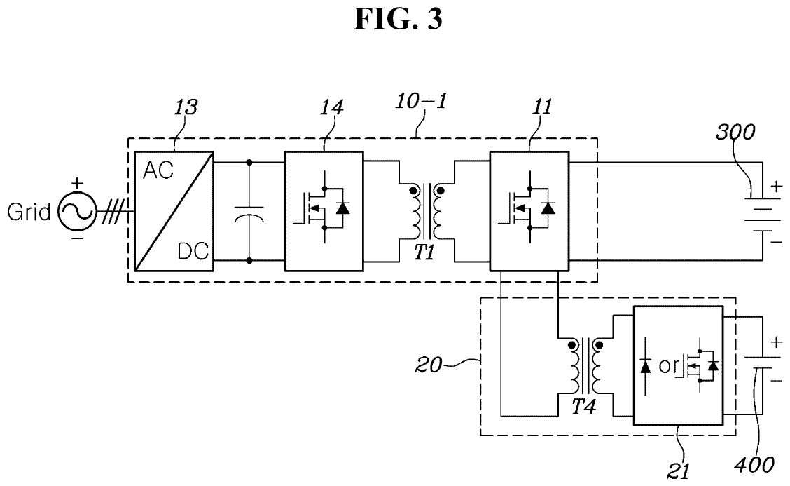

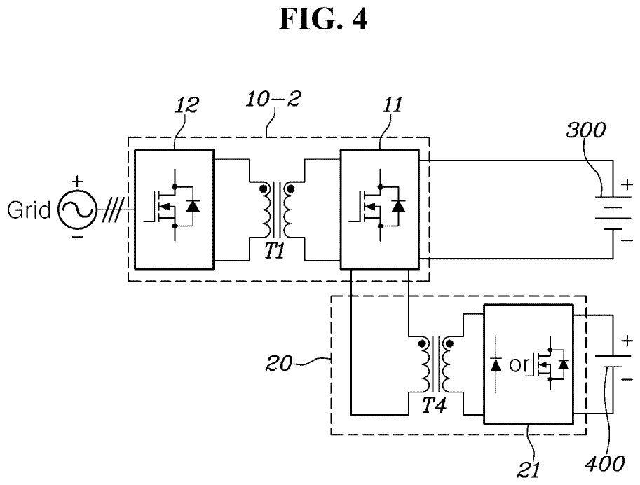

FIG. 3 is a circuit diagram of an integrated charger according to an embodiment of the present invention, and FIG. 4 is a circuit diagram of an integrated charger according to another embodiment of the present invention.

Referring to FIGS. 3 and 4, the integrated charger according to the embodiment of the present invention may include a first isolated charger 10-1 or 10-2 configured to convert AC voltage input from the outside, such as a grid, into first DC voltage for charging a first battery 300 corresponding to a high-voltage battery and to provide the converted voltage to the first battery 300 and a second isolated charger 20 including a transformer T4 having a first winding wire connected to a transformer Tl of the first isolated charger 10-1 or 10-2 and a first battery-side switching circuit 11 and a second winding wire electromagnetically coupled to the first winding wire to convert the magnitude of voltage of the first winding wire and to output the voltage having the converted magnitude and a rectification circuit 21 configured to rectify the voltage of the second winding wire into second DC voltage having a smaller magnitude than the first DC voltage and to provide the rectified voltage to a second battery 400 corresponding to a low-voltage battery. Here, the first isolated charger 10-1 or 10-2 may correspond to an OBC, and the second isolated charger 20 may correspond to an LDC.

The embodiments of FIGS. 3 and 4 differ in the configuration of the first isolated charger corresponding to the OBC circuit, wherein FIG. 3 shows an embodiment in which the first isolated charger has a two-stage structure, and FIG. 4 shows an embodiment in which the first isolated charger has a one-stage structure.

The first isolated charger 10-1 shown in FIG. 3 may include an AC-DC conversion stage 13 configured to convert external AC voltage into DC link voltage, a transformer T1, an AC-side inverter portion 14 connected between the AC-DC conversion stage 13 and the transformer T1, and a rectification portion 11 connected between the transformer T1 and an output end to convert the voltage whose magnitude is converted by the transformer T1 into direct current. The DC voltage converted by the rectification portion 11 may be provided to the high-voltage battery 300.

The first isolated charger 10-2 shown in FIG. 4 is a charger having a structure in which input and output ends having a single-stage AC-side inverter portion 12, a rectification portion 11, and a transformer T1 connected therebetween are isolated from each other. The AC-side inverter portion 12 and the rectification portion 11 may be implemented by a switching circuit, such as a bridge circuit including a switching element, and voltage in the form of alternating current whose magnitude is converted by the transformer T1 may be converted by the rectification portion 11 and provided to the high-voltage battery 300.

The embodiments shown in FIGS. 3 and 4 have in common the rectification portion 11 connected between a secondary side of the transformer T1 and the high-voltage battery 300. The rectification portion 11 may be implemented by a switching circuit in the form of a bridge circuit having a plurality of legs each including two switching elements connected between both ends of the high-voltage battery 300, respectively.

The second isolated charger 20 may include a transformer T4 having a primary winding wire connected to the switching circuit corresponding to the rectification portion 11 of the first isolated charger 10 and a rectification portion 21 connected to a secondary winding wire of the transformer T4.

The second isolated charger 20 may convert the magnitude of voltage of DC power of the high-voltage battery 300 and provide the converted power to the low-voltage battery 400 to charge the low-voltage battery 400. The switching circuit 11 corresponding to the DC side of the first isolated charger 10, i.e., the rectification portion connected to the high-voltage battery, may serve as an inverter configured to provide voltage in the form of alternating current to the primary side of the transformer T4 of the second isolated charger 20.

The transformer T4 may convert (reduce) the magnitude of the voltage input to the primary side according to the wiring ratio of the primary winding wire to the secondary winding wire and may provide the voltage having the converted magnitude to the secondary winding wire, and the voltage of the secondary winding wire may be converted into direct current by the rectification circuit 21 and provided to the low-voltage battery 400.

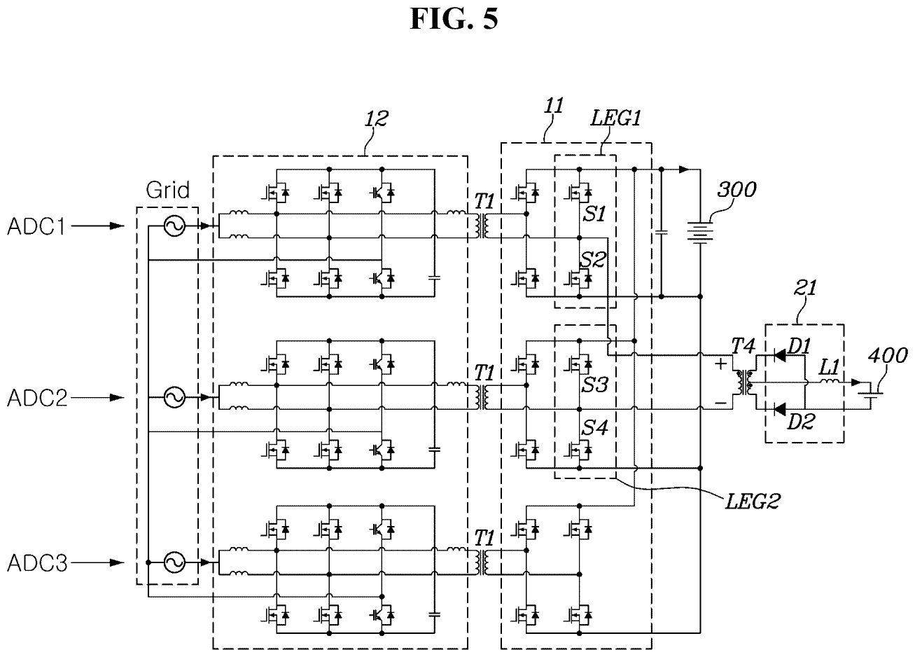

FIG. 5 is a circuit diagram showing a more specific circuit configuration of the integrated charger according to the embodiment of the present invention.

Referring to FIG. 5, AC voltage input from the outside may be three-phase AC voltage having a certain phase difference, and the first isolated charger corresponding to the OBC may have a structure including a plurality of isolated AC-DC conversion circuits ADC1 to ADC3 connected in parallel to the high-voltage battery 300 in order to convert each phase of multi-phase AC voltage. Each of the plurality of isolated AC-DC conversion circuits ADC1 to ADC3 may include a transformer T1 and a rectification portion connected between the transformer T1 and the high-voltage battery 300.

In an example having the structure of the first isolated charger, two arbitrary legs LEG1 and LEG2, among legs included in the rectification portions, may be connected to both ends of the primary winding wire of the transformer T4 of the second isolated charger, respectively, to constitute an inverter circuit of the LDC implemented by the second isolated charger. In the embodiment of FIG. 5, the leg LEG1 included in the first isolated AC-DC conversion circuit ADC1 and the leg LEG2 included in the second isolated AC-DC conversion circuit ADC2 may be connected to both ends of the primary side winding wire of the transformer T4, respectively. More specifically, a connection node of switching elements S1 and S2 included in the leg LEG1 may be connected to one end of the primary winding wire of the transformer T4, and a connection node of switching elements S3 and S4 included in the leg LEG2 may be connected to the other end of the primary winding wire of the transformer T4.

In addition, the embodiment of FIG. 5 may be implemented in the form of a phase shift full bridge (PSFB) converter in which the rectification circuit 21 connected to the secondary winding wire of the transformer T4 of the second isolated charger is operated in a PWM mode.

More specifically, in the embodiment of FIG. 5, the rectification circuit 21 of the second isolated charger may include a first diode D1 having a cathode connected to one end of the second winding wire of the transformer T4, a second diode D2 having a cathode connected to the other end of the second winding wire of the transformer T4 and an anode connected to an anode of the first diode D1, and an inductor L1 having one end connected to a center end of the second winding wire of the transformer T4, wherein the low-voltage battery 400 may be connected between the other end of the inductor L1 and the anode of the second diode D2.

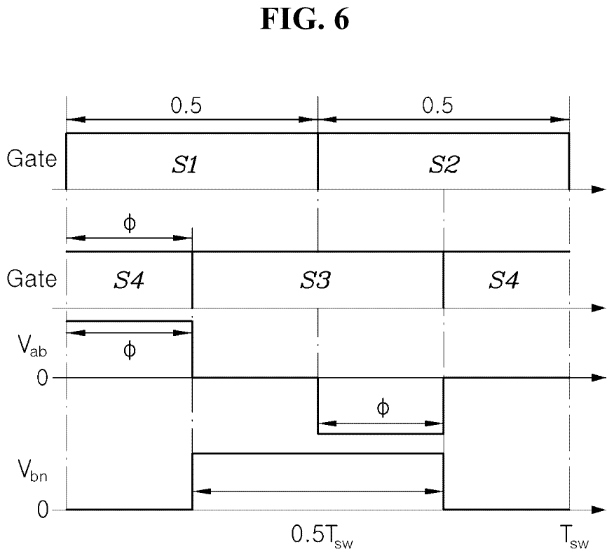

FIG. 6 is a waveform diagram showing a switching state when the first isolated charger and the second isolated charger are operated simultaneously in the embodiment of FIG. 5.

As shown in FIG. 6, the switching elements S1 and S2 of the first leg LEG1 and the switching elements S3 and S4 of the second leg LEG2 are turned on/off at the same cycle and duty, and the switching elements in each leg may be alternately turned on/off. Particularly, in the embodiment of the present invention, a phase difference φ may be provided between the switching elements S1 and S2 of the first leg LEG1 and the switching elements S3 and S4 of the second leg LEG2 to determine the voltage Vab between the connection node of the two switching elements S1 and S2 and the connection node of the two switching elements S3 and S4, and the voltage Von between the connection node of the two switching elements S3 and S4 and a negative electrode of the high-voltage battery 300 may be fixed so as to occur during ½ of the switching cycle of the switching elements S1 to S4, whereby charging of the high-voltage battery 200 and the supply of power to the second isolation charger may be performed simultaneously.

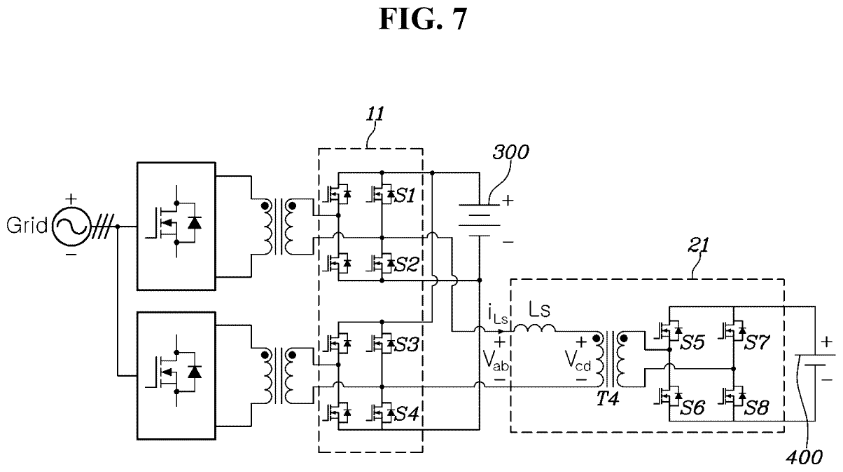

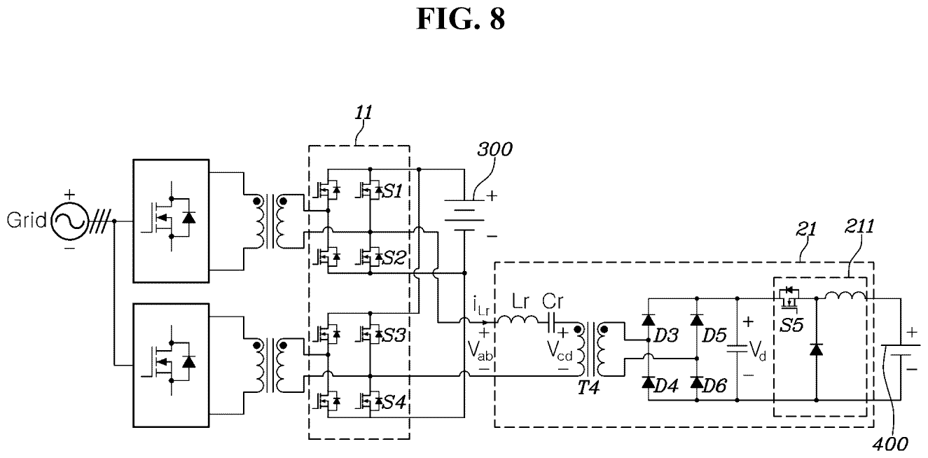

FIGS. 7 and 8 are circuit diagrams showing other embodiments of the present invention in which, particularly, rectification circuits of second isolated chargers are configured differently. Since the embodiments of FIGS. 7 and 8 have substantially the same circuit configuration of a first isolated circuit portion as the embodiment of FIG. 6, a description of the circuit configuration of the first isolated circuit part will be omitted.

Referring to FIG. 7, in the integrated charger according to the embodiment of the present invention, the rectification circuit 21 of the second isolation charger may be implemented in the structure of a dual active bridge (DAB) converter. In the embodiment of FIG. 7, the rectification circuit 21 implemented in the structure of the DAB converter may include a fifth switching element S5 and a sixth switching element S6 each having one end connected to one end of the second winding wire of the transformer T4 and a seventh switching element S7 and an eighth switching element S8 each having one end connected to the other end of the second winding wire of the transformer T4. The other end of the fifth switching element S5 and the other end of the seventh switching element S7 may be connected to one end of the second battery 400, and the other end of the sixth switching element S6 and the other end of the eighth switching element S8 may be connected to the other end of the second battery 400.

The rectification circuit 21 implemented in the structure of the DAB converter, as shown in FIG. 7, may be controlled in a single phase-shift (SPS) mode. Specifically, among the switching elements provided in the switching circuit of the first isolation charger, the switching elements S1 and S2 of the first leg LEG1 are alternately switched at the same cycle and duty, the switching elements S3 and S4 of the second leg LEG2 are alternately switched at the same cycle and duty, the first switching element S1 and the fourth switching element S4 may be switched at the same timing, and the second switching element S2 and the third switching element S3 may be switched at the same timing.

Similarly, the fifth switching element S5 and the eighth switching element S8 may be switched at the same timing, the sixth switching element S6 and the seventh switching element S7 may be switched at the same timing, the fifth switching element S5 and the sixth switching element S6 may be alternately switched at the same cycle, and the seventh switching element S7 and the eighth switching element S8 may be alternately switched at the same cycle. Here, the first switching element S1 and the fifth switching element S5 are switched with a phase difference. By control of the switching elements with the phase difference, a voltage difference is generated in an inductor Ls connected between the primary winding wire of the transformer T4 and the connection node of the first switching element S1 and the second switching element S2, whereby inductor current is generated, enabling current to be supplied to the low-voltage battery 400.

Next, referring to FIG. 8, in the integrated charger according to the embodiment of the present invention, the rectification circuit 21 of the second isolated charger may be implemented by a two-stage converter including a diode rectifier and boost converter structure. In the embodiment of FIG. 8, the rectification circuit 21 may include a diode D3 having an anode connected to one end of the second winding wire of the transformer T4, a diode D4 having a cathode connected to one end of the second winding wire, a third diode D5 having an anode connected to the other end of the second winding wire, a diode D6 having a cathode connected to the other end of the second winding wire, and a booster converter circuit 211 configured to convert the magnitude of the voltage between the cathode of the diode D3 and the anode of the diode D4 and to provide the voltage having the converted magnitude to the second battery.

In the rectification circuit 21 according to the embodiment shown in FIG. 8, among the switching elements provided in the switching circuit of the first isolation charger, the switching elements S1 and S2 of the first leg LEG1 may be alternately switched at the same cycle and duty, the switching elements S3 and S4 of the second leg LEG2 may be alternately switched at the same cycle and duty, the first switching element S1 and the fourth switching element S4 are switched at the same timing, and the second switching element S2 and the third switching element S3 may be switched at the same timing. Accordingly, the voltage at both ends of the primary coil of the transformer T4 is determined, and alternating current that is provided to the primary coil is generated by an inductor Lr and a capacitor Cr connected to the primary coil of the transformer T4. The voltage Vd output from the diode bridge circuit of the rectification circuit 21 may be controlled by a boost converter 211, which is a non-isolated converter, and may be provided to the second battery 400.

As described above, in the integrated charger according to various embodiments of the present invention, the switching circuit (rectification circuit) of the DC side of the conventional OBC and the switching circuit (inverter circuit) of the high-voltage side (input side) of the conventional LDC are integrated, and therefore the number of elements may be reduced, whereby it is possible to achieve product miniaturization and to reduce manufacturing costs, and the number of power conversion steps may be reduced, whereby it is possible to improve energy efficiency. Furthermore, the technical features of the integrated charger according to the various embodiments of the present invention described above may be universally applied to isolated chargers using different circuit structures.

### DESCRIPTION OF REFERENCE NUMERALS

10-1, 10-2: First isolated chargers
11: DC-side switching circuit 12: AC-side switching circuit
20: Second isolated charger 21: Rectification circuit

1. An integrated charger comprising:
a first isolated charger configured to convert AC voltage input from an outside into first DC voltage for charging a first battery and to provide the converted voltage to the first battery; and
a second isolated charger comprising a transformer having a first winding wire connected to a switching circuit of the first isolated charger connected to the first battery and a second winding wire electromagnetically coupled to the first winding wire to convert the magnitude of voltage of the first winding wire and to output the voltage having the converted magnitude and a rectification circuit configured to rectify the voltage of the second winding wire into second DC voltage having a smaller magnitude than the first DC voltage and to provide the rectified voltage to a second battery.

2. The integrated charger according to claim 1, wherein
the AC voltage is a multi-phase AC voltage having a plurality of phases,
the first isolated charger comprises a plurality of isolated AC-DC conversion circuits connected in parallel to the first battery in order to convert each phase of the multi-phase AC voltage, and
the second isolated charger generates the first winding wire-side voltage through switching control of switching elements included in the first battery-side switching circuit provided in two arbitrary isolated AC-DC conversion circuits among the plurality of isolated AC-DC conversion circuits.

3. The integrated charger according to claim 1, wherein
the first battery-side switching circuit comprises a first leg comprising a first switching element and a second switching element connected to both ends of the first battery, respectively, the first switching element and the second switching element being connected to each other in series, and a third switching element and a fourth switching element connected to both ends of the first battery, respectively, the third switching element and the fourth switching element being connected to each other in series, and
a connection node of the first switching element and the second switching element and a connection node of the third switching element and the fourth switching element are connected to both ends of the first winding wire, respectively.

4. The integrated charger according to claim 3, wherein the rectification circuit of the second isolated charger comprises:
a first diode having a cathode connected to one end of the second winding wire;
a second diode having a cathode connected to the other end of the second winding wire and an anode connected to an anode of the first diode; and
an inductor having one end connected to a center end of the second winding wire, and
both ends of the second battery are connected between the other end of the inductor and the anode of the second diode.

5. The integrated charger according to claim 3, wherein
the rectification circuit of the second isolated charger comprises:
a fifth switching element and a sixth switching element each having one end connected to one end of the second winding wire; and
a seventh switching element and an eighth switching element each having one end connected to the other end of the second winding wire,
the other end of the fifth switching element and the other end of the seventh switching element are connected to one end of the second battery, and
the other end of the sixth switching element and the other end of the eighth switching element are connected to the other end of the second battery.

6. The integrated charger according to claim 3, wherein the rectification circuit of the second isolated charger comprises:
a first diode having an anode connected to one end of the second winding wire;
a second diode having a cathode connected to one end of the second winding wire;
a third diode having an anode connected to the other end of the second winding wire;
a fourth diode having a cathode connected to the other end of the second winding wire; and
a non-isolated DC-DC converter circuit configured to convert a magnitude of voltage between the cathode of the first diode and the anode of the second diode and to provide the voltage having the converted magnitude to the second battery.

7. The integrated charger according to claim 3, wherein
the first switching element and the second switching element are alternately switched at the same cycle and duty,
the third switching element and the fourth switching element are alternately switched at the same cycle and duty as the first switching element, and
voltage at both ends of the first winding wire is determined through phase difference control of the first switching element and the third switching element.

8. The integrated charger according to claim 7, wherein voltage between the connection node of the third switching element and the fourth switching element and a negative electrode of the first battery is fixed so as to occur during ½ of the switching cycle of the first to fourth switching elements.
